(19) United States
(12) Patent Application Publication
(10) Pub. No.: US 2016/0170549 A1
(43) Pub. Date: Jun. 16, 2016

(54) TOUCH SENSOR DEVICE AND DISPLAY DEVICE INCLUDING THE SAME

(71) Applicant: Samsung Display Co., Ltd., Yongin-city (KR)

(72) Inventor: Jun NAMKUNG, Asan-si (KR)

(21) Appl. No.: 14/740,677

(22) Filed: Jun. 16, 2015

(30) Foreign Application Priority Data
Dec. 15, 2014 (KR) 10-2014-0180396
Jan. 28, 2015 (KR) 10-2015-0013369

(51) Int. Cl. G06F 3/041; G06F 3/01; G06F 3/0354; G06F 3/0488

(52) U.S. Cl. CPC G06F 3/0416; G06F 3/0412; G06F 3/0414; G06F 3/0488; G06F 3/017; G06F 3/03545; G06F 2203/04102; G06F 2203/04808; G06F 2203/04103

(57) ABSTRACT

The present disclosure relates to a touch sensor device and a display device including the same. More particularly, the present disclosure relates to a flexible touch sensor device and a display device including the same. A touch sensor device according to an exemplary embodiment of the present disclosure includes: a first touch substrate and a second touch substrate facing each other; and a touch electrode layer positioned between the first touch substrate and the second touch substrate, wherein the touch electrode layer includes a plurality of first touch electrodes positioned on the first touch substrate, a plurality of second touch electrodes positioned on the second touch substrate, and a middle layer positioned between the first touch electrode and the second touch electrode, and the middle layer includes at least one among a ductile polymer, a liquid film, a resin, a photoresist, and a nonpolar solder resist.

### CROSS-REFERENCE TO RELATED APPLICATIONS

This application claims priority from and the benefit of Korean Patent Application No. 10-2014-0180396, filed on Dec. 15, 2014, and Korean Patent Application No. 10-2015-0013369, filed on Jan. 28, 2015, which are hereby incorporated by reference for all purposes as if fully set forth herein.

### BACKGROUND

1. Field

Exemplary embodiments relate to a touch sensor device and a display device including the same. More particularly, the present disclosure relates to a flexible touch sensor device and a display device including the same.

2. Discussion of the Background

An electronic device such as a liquid crystal display (LCD), an organic light emitting diode (OLED) display, and an electrophoretic display may include a touch sensing function such that it is capable of user interaction. A touch sensing function determines whether a user finger, etc., touches a screen, and touch position information thereof, by sensing a change of pressure, light, etc., that occurs on a screen in the display device when the user's finger or a touch pen contacts to the screen to write a character or to draw a picture.

The touch sensing function of many types of electronic devices may be realized through a touch sensor. The touch sensor may be classified into various types such as a resistive type, a capacitive type, an electro-magnetic (EM) type, and an optical type.

For example, the capacitive touch sensor includes a sensing capacitor formed by a sensing electrode which may transfer a sensing signal, and senses a change in capacitance of the sensing capacitor generated when a conductor such as a finger approaches the touch sensor to determine existence of a touch, a touch position, and the like. The capacitive touch sensor may include a plurality of touch electrodes disposed in a touch sensing region for sensing the touch and touch wires connected to the touch electrodes. The touch wires may transmit a sensing input signal to the touch electrode and transmit a sensing output signal of the touch electrode generated depending on the touch to a touch driver.

The touch sensor may be installed in the display device (an in-cell type), formed on an outer surface of the display device (an on-cell type), or attached as a separate touch sensor panel to the display device (an add-on cell type). Particularly, in a case of a flexible display device, an add-on cell type may be used by adhering a film in which the touch sensor is formed on to the display panel or by forming and adhering a separate touch sensor device having a plate shape on the display panel.

When electronic devices such as the display device are used, the touch sensor device uses a glass substrate that is heavy and easily damaged. Accordingly, this limits its portability and implementation in a large-scale screen display. Thus, a flexible electronic device which is light, impact-resistant, and uses a plastic substrate having high flexibility such as polyimide (PI) has been actively developed. In the manufacturing process of the electronic device, a glass substrate may be used. However, the glass substrate is finally attached or detached by using a laser, and a protection film, such as polyethylene terephthalate (PET) including an adhesion layer to protect the surface of the flexible substrate, may be adhered thereto.

As described above, the flexible electronic devices including the substrate having flexibility may include a portion that is foldable, rollable, stretchable in at least one direction, or is elastic and can be deformed.

The deformed portion, when the flexible electronic device is bent or folded, receives mechanical stress, and the stress may change depending on a curvature radius and a distance from a neutral plane.

The above information disclosed in this Background section is only for enhancement of understanding of the background of the inventive concept, and, therefore, it may contain information that does not form the prior art that is already known in this country to a person of ordinary skill in the art.

### SUMMARY

Stress applied to the deformed portion of the touch sensor device may cause a failure, such as a crack of the touch electrode, when the bending or the folding is performed.

Accordingly, exemplary embodiments provide an inventive concept that prevents the failure of the touch sensor by the deformation by minimizing mechanical stress applied to the touch electrode when the flexible touch sensor device is deformed.

Additional aspects will be set forth in the detailed description which follows, and, in part, will be apparent from the disclosure, or may be learned by practice of the inventive concept.

According to exemplary embodiments, a touch sensor device includes: a first touch substrate and a second touch substrate facing each other; and a touch electrode layer positioned between the first touch substrate and the second touch substrate, wherein the touch electrode layer includes a plurality of first touch electrodes positioned on the first touch substrate, a plurality of second touch electrodes positioned on the second touch substrate, and a middle layer positioned between the first touch electrode and the second touch electrode, and the middle layer includes at least one among a ductile polymer, a liquid film, a resin, a photoresist, and a nonpolar solder resist.

A display device according to an exemplary embodiment includes: a display panel displaying an image; and a touch sensor device positioned on the display panel, wherein the touch sensor device includes a first touch substrate and a second touch substrate facing each other, and a touch electrode layer positioned between the first touch substrate and the second touch substrate. The touch electrode layer includes a plurality of first touch electrodes positioned on the first touch substrate, a plurality of second touch electrodes positioned on the second touch substrate, and a middle layer positioned between the first touch electrode and the second touch electrode, and the middle layer includes at least one among a ductile polymer, a liquid film, a resin, a photoresist, and a nonpolar solder resist.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a top plan view of a touch sensor device according to an exemplary embodiment.

FIG. 2 is a cross-sectional view of the touch sensor device shown in FIG. 1 taken along a line II-II.

FIG. 3 is a cross-sectional view of a state in which a touch sensor device according to an exemplary embodiment is deformed.

FIG. 4 is a cross-sectional view of the touch sensor device shown in FIG. 1 taken along the line II-II.

FIG. 5 is a cross-sectional view of a first touch substrate in a manufacturing process according to an exemplary embodiment.

FIG. 6 is a cross-sectional view of a second touch substrate in a manufacturing process according to an exemplary embodiment.

FIG. 7 is a cross-sectional view of a display device including a touch sensor device according to an exemplary embodiment.

FIG. 8 is a cross-sectional view showing an assembling method of a display panel, a touch sensor device, and a cover window in a manufacturing process of the display device shown in FIG. 7.

FIG. 9 is a cross-sectional view of a display device including a touch sensor device according to an exemplary embodiment.

FIG. 10 is a cross-sectional view showing an exemplary embodiment of an assembling method of a display panel, a touch sensor device, a polarizer, and a cover window in a manufacturing process of the display device shown in FIG. 9.

FIG. 11 is a cross-sectional view showing another exemplary embodiment of an assembling method of a display panel, a touch sensor device, a polarizer, and a cover window in a manufacturing process of the display device shown in FIG. 9.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

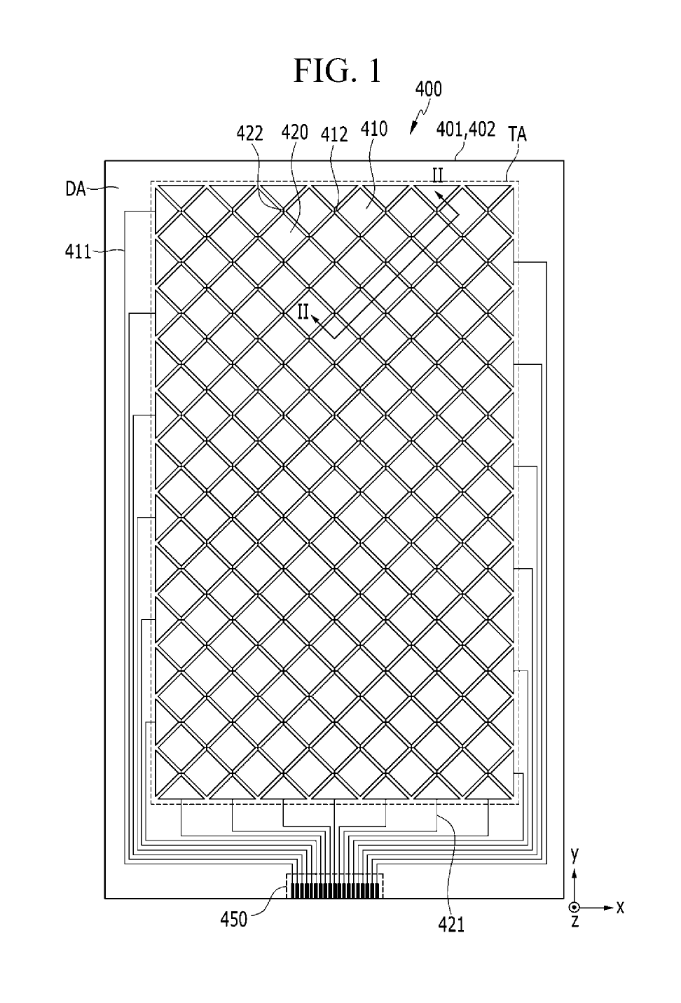

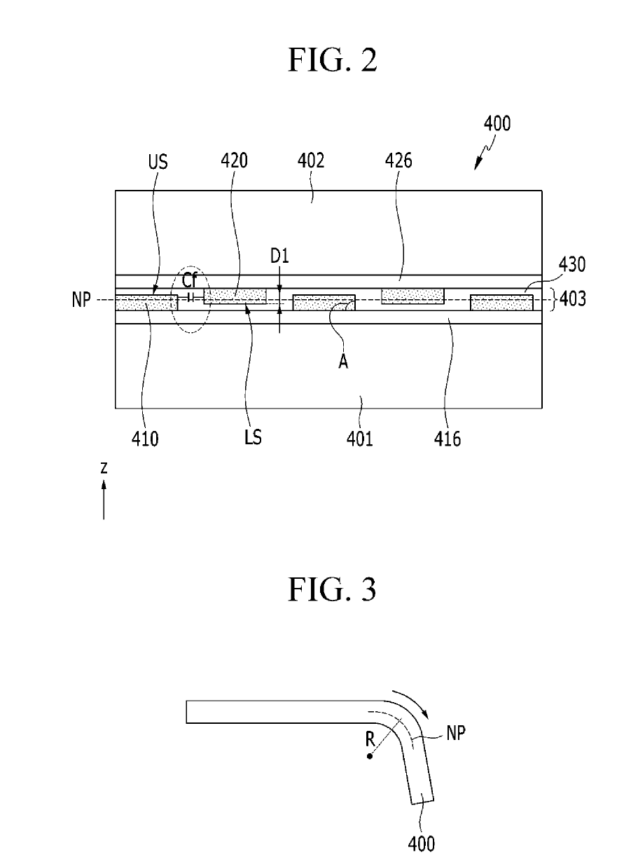

A touch sensor device according to an exemplary embodiment will now be described with reference to FIG. 1, FIG. 2, and FIG. 3.

FIG. 1 is a top plan view of a touch sensor device according to an exemplary embodiment, FIG. 2 is a cross-sectional view of the touch sensor device shown in FIG. 1 taken along line II-II, and FIG. 3 is a cross-sectional view of a state in which a touch sensor device according to an exemplary embodiment is deformed.

Referring to FIG. 1 and FIG. 2, a touch sensor device 400 according to an exemplary embodiment may sense a contact by an external object. Here, the sensed contact includes a case where the external object approaches the touch sensor device 400 or hovers in the approached state, as well as a case where the external object, such as a finger of the user, directly contacts the surface of a display device 1.

Referring to FIG. 2, the touch sensor device 400 according to an exemplary embodiment includes a first touch substrate 401, a second touch substrate 402 facing the first touch substrate 401, and a touch electrode layer 403 positioned between the first and second touch substrates 401 and 402 in a view of the cross-sectional structure, that is, in a view of a z-axis direction of the structure. Referring to FIG. 1, in a plan view, that is, in a view of an x-y plane structure, the touch sensor device 400 includes a touch sensing region TA as a region where the contact by the external object may be sensed and a non-sensing region DA outside the touch sensing region TA. The non-sensing region DA may also be referred to as a dead space.

The first and second touch substrates 401 and 402 may include a flexible film. For example, the first and second touch substrates 401 and 402 may include polyethylene terephthalate (PET), polyethylene naphthalate, polycarbonate, polyarylate, polyetherimide, polyether sulfone, polyimide, and the like.

The thickness of the first touch substrate 401 in the z-axis direction may be substantially the same as the thickness of the second touch substrate 402 in the z-axis direction, but it is not limited thereto.

The touch electrode layer 403 includes a plurality of touch electrodes 410 and 420 and a middle layer 430. According to an exemplary embodiment, the touch electrode layer 403 may further include a plurality of touch wires 411 and 421 connected to the touch electrodes 410 and 420.

The plurality of touch electrodes 410 and 420 may be positioned mainly in the touch sensing region TA, and the touch wires 411 and 421 may be positioned in the touch sensing region TA or in the non-sensing region DA.

The touch electrodes 410 and 420 may have more than a predetermined transmittance rate to transmit light. For example, the touch electrodes 410 and 420 may include a transparent conductive oxide such as ITO (indium tin oxide) and IZO (indium zinc oxide), however it is not limited thereto, and may include at least one of a transparent conductive material such as a metal nanowire, a conductive polymer such as poly 3,4-ethylenedioxythiophene (PEDOT), a metal mesh, and carbon nanotubes (CNT).

The touch wires 411 and 421 may include the transparent conductive material included in the touch electrode 410 and 420 and/or a low resistance material such as molybdenum (Mo), silver (Ag), titanium (Ti), copper (Cu), aluminum (Al), and molybdenum/aluminum/molybdenum (Mo/Al/Mo).

The touch wires 411 and 421 may include a portion that is positioned in the same layer as the touch electrode 410 and 420, or not.

The touch electrodes 410 and 420 form a touch sensor that may sense contact by various methods. The touch sensor may be a touch sensor using various methods such as a resistive type, a capacitive type, an electro-magnetic (EM) type, and an optical type. In the present exemplary embodiment, a capacitive type of touch sensor will be described, although embodiments are not limited thereto.

The capacitive type of touch sensor may receive a sensing input signal from a touch driver (not shown) by one of the touch electrodes 410 and 420, and may output a sensing output signal that changes depending on contact of the external object.

When the touch electrodes 410 and 420 form a self-sensing capacitor with a foreign object, the touch electrodes receive the sensing input signal and are charged with a predetermined amount of charges, and when there is a contact by a foreign object such as a finger, the amount of charges stored in the self-sensing capacitor is changed and a sensing output signal that is different from the input sensing input signal is output. Contact information such as a contact state or a contact position is known by the change of the sensing output signal.

When neighboring touch electrodes 410 and 420 form a mutual-sensing capacitor (Cf), one touch electrode receives the sensing input signal from the driver and the self-sensing capacitor is charged with a predetermined amount of charge. When there is a contact by a foreign object such as a finger, the stored amount of charge of the self-sensing capacitor is changed and the changed amount of charge is output as a sensing output signal through the touch electrodes 410 and 420. The contact information such as a contact state or a contact position is known by the sensing output signal.

The touch sensor forming the mutual-sensing capacitor will be described in the present exemplary embodiment as an example.

Referring to FIG. 1 and FIG. 2, the touch electrodes 410 and 420 of the touch sensor according to an exemplary embodiment may include a plurality of first touch electrodes 410 and a plurality of second touch electrodes 420. The first touch electrodes 410 and the second touch electrodes 420 are separated from each other.

The first touch electrodes 410 and the second touch electrodes 420 may be disposed to be alternately distributed such that they do not overlap each other in the touch active area TA in a plane. The plurality of first touch electrodes 410 are disposed along a column direction and a row direction, and the plurality of second touch electrodes 420 are also disposed along a column direction and a row direction. The column direction may be the x-axis direction shown in FIG. 1 and the row direction may be the y-axis direction.

Particularly, the first touch electrode 410 is positioned on the first touch substrate 401, and the second touch electrode 420 is positioned on the second touch substrate 402. According to the present exemplary embodiment, the upper surface US of the first touch electrode 410 may be higher than the lower surface LS of the second touch electrode 420. That is, the thickness of the first touch electrode 410 and the second touch electrode 420 in the z-axis direction is higher than half of the thickness of the middle layer 430, and a distance D1 between the upper surface US of the first touch electrode 410 and the lower surface LS of the second touch electrode 420 in the z-axis direction may be larger than 0. Accordingly, the distance between the adjacent first and second touch electrodes 410 and 420 is reduced such that the capacitance of the mutual sensing capacitor Cf may be increased, thereby increasing the sensitivity of the touch sensor.

The thickness of the first touch electrode 410 in the z-axis direction may be substantially the same as the thickness of the second touch electrode 420 in the z-axis direction, but it is not limited thereto.

The middle layer 430 is positioned between the first touch electrode 410 and the second touch electrode 420, and the middle layer 430 may be disposed between the first touch substrate 401 and the second touch substrate 402. The middle layer 430 may include at least one selected from a group of a ductile polymer, a liquid film, a resin, a photoresist, and a nonpolar solder resist. The photoresist may be a dry film photoresist (DFR) as an example.

As described above, by positioning the middle layer 430 between the first touch electrode 410 and the second touch electrode 420, the upper surface US of the first touch electrode 410 may be higher than the lower surface LS of the second touch electrode 420 in the manufacturing process of the touch sensor device 400. Accordingly, the upper surface US of the first touch electrode 410 may be positioned to be close to the second touch substrate 402 and the lower surface LS of the second touch electrode 420 may be positioned to be close to the first touch substrate 401.

Referring to FIG. 2, a protection layer 416 may be further positioned between the first touch substrate 401 and the first touch electrode 410, and a protection layer 426 may be further positioned between the second touch substrate 402 and the second touch electrode 420. The protection layers 416 and 426 may include an insulating material such as a silicon nitride (SiNx) and an aluminum oxide (AlOx). The protection layers 416 and 426 prevent scratching of the first and second touch substrates 401 and 402, thereby protecting the first and second touch substrates 401 and 402.

Referring to FIG. 2 and FIG. 3, according to an exemplary embodiment, the touch sensor device 400 may be deformed with a curvature radius R such as through bending or folding, or may be fixed in the modified state in which the touch sensor device 400 is already folded or bent. In this case, the neutral plane NP is a position where the strain of the bent portion of the touch sensor device 400 is substantially 0 at the touch electrode layer 403. Accordingly, during deformation of the touch sensor device 400, the stress applied to the touch electrode 410 and 420 is very small such that damage, such as a crack, may not be generated in the touch electrode 410 and 420.

Also, the middle layer 430 is positioned between the first touch electrode 410 and the second touch electrode 420 such that the upper surface US of the first touch electrode 410 is positioned to be close to the second touch substrate 402 and the lower surface LS of the second touch electrode 420 is positioned to be close to the first touch substrate 401, and when deforming the touch sensor device 400, the neutral plane NP is aligned or is positioned to be close to the first and second touch electrodes 410 and 420, thereby preventing damage of the touch electrodes 410 and 420.

Particularly, according to an exemplary embodiment, the touch sensor device 400 has a vertical symmetric structure with respect to the touch electrode layer 403 such that it is easy for the neutral plane NP to be positioned at the touch electrode layer 403. As shown in FIG. 2, the touch substrates 401 and 402 are respectively positioned up and down with respect to the touch electrode layer 403 including the touch electrodes 410 and 420 and the middle layer 430 such that the neutral plane may be positioned at the touch electrode layer 403 even if the touch sensor device 400 is bent and folded in another direction.

In the touch electrode layer 403, the position of the neutral plane NP may be controlled by controlling the thickness, the elasticity coefficient, and the curvature radius R of the first and second touch substrates 401 and 402 included in the touch sensor device 400, the protection layers 416 and 426, the first and second touch electrode 410 and 420, and the middle layer 430.

When forming the first and second touch electrodes on the same touch substrate, an additional protection film is generally adhered on the first and second touch electrodes by using an adhesive. However, the touch sensor device 400 according to the present exemplary embodiment does not necessarily require the additional protection film such that the overall thickness of the touch sensor device 400 may be reduced. Accordingly, flexibility of the flexible touch sensor device 400 may be further increased.

The first touch electrode 410 and the second touch electrode 420 respectively may have a quadrangle shape in plan view, however exemplary embodiments are not limited thereto, and they may have various shapes having protrusions for sensitivity improvement of the touch sensor.

Referring to FIG. 2, in cross-section, the side of the first and second touch electrodes 410 and 420 may form a right angle A with the surface of the first and second touch substrates 401 and 402, but exemplary embodiments are not limited thereto.

The plurality of first touch electrodes 410 arranged in the same column or row may be connected to each other outside or inside the touch sensing region TA. Likewise, the plurality of second touch electrodes 410 arranged in the same column or row may be connected to each other outside or inside the touch sensing region TA. For example, as shown in FIG. 1, the plurality of first touch electrodes 410 positioned in each row may be connected through a first connection portion 412 and the plurality of second touch electrodes 420 positioned in each column may be connected to each other through a second connection portion 422.

Referring to FIG. 1, the first touch electrodes 410 connected to each other in each row are connected to a touch driver through the first touch wires 411, and the second touch electrodes 420 connected in each column are connected to the touch driver through the second touch wires 421. The first touch wires 411 and the second touch wires 421 may be disposed in the non-sensing region DA, however they may be alternatively disposed in the touch sensing region TA.

Ends of the first touch wires 411 and the second touch wires 421 may form a pad portion 450 in the non-sensing region DA of the touch sensor device 400.

The first touch wires 411 may input the sensing input signal to the first touch electrode 410 or may output the sensing output signal to the touch driver through the pad portion 450. The second touch wires 421 may input the sensing input signal to the second touch electrode 420 or may output the sensing output signal to the touch driver through the pad portion 450.

The touch driver controls the operation of the touch sensor. The touch driver may transmit the sensing input signal to the touch sensor and may receive the sensing output signal to be processed. The touch driver processes the sensing output signal to generate the touch information such as the touch and the touch position.

The first touch electrode 410 and the second touch electrode 420 adjacent to each other may form the mutual sensing capacitor Cf serving as the touch sensor. The mutual sensing capacitor Cf may receive the sensing input signal through one of the first touch electrode 410 and the second touch electrode 420, and may output the change of the charge amount by the contact of the external object as the sensing output signal to the rest of the touch electrodes.

Alternatively, a plurality of first touch electrodes 410 and a plurality of second touch electrodes 420 may be separated from each other, and may be respectively connected to the touch driver through the touch wires (not shown). In this case, the touch electrode 410 and 420 may form the self-sensing capacitor as the touch sensor. The self-sensing capacitor receives the sensing input signal to be charged by a predetermined charge amount, and may output a sensing output signal that is different from the sensing input signal which is input due to a change in the charge amount generated when the external object such as a finger makes contact.

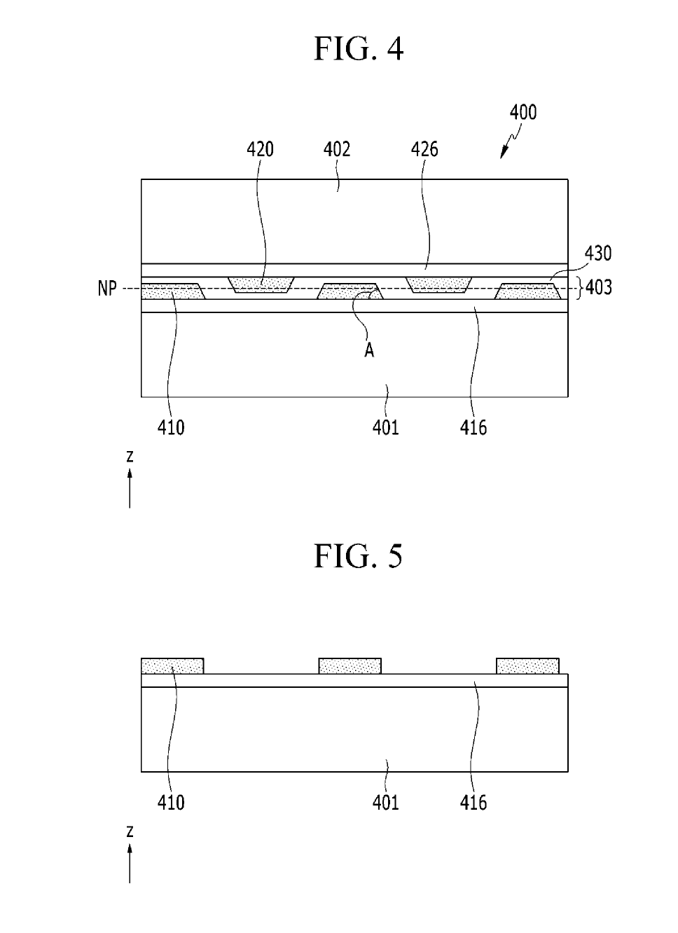

Next, the touch sensor device according to an exemplary embodiment will be described with reference to FIG. 4 along with the above-described drawings.

FIG. 4 is an exemplary embodiment of a cross-sectional view of the touch sensor device shown in FIG. 1 taken along a line II-II.

Referring to FIG. 4, the touch sensor device 400 according to the present exemplary embodiment is the same as most of the touch sensor device according to the previous exemplary embodiment except for the cross-sectional shape of the first and second touch electrodes 410 and 420. According to the present exemplary embodiment, the side of the first and second touch electrodes 410 and 420 may form an acute angle of A with the surface of the first and second touch substrates 401 and 402. That is, the side of the first and second touch electrodes 410 and 420 may be inclined with respect to the surface of the first and second touch substrates 401 and 402.

According to the present exemplary embodiment, during bending or folding the touch sensor device 400, the stress applied to the first and second touch electrodes 410 and 420 is not concentrated to the lower portion near the first and second touch substrates 401 and 402, but may be dispersed along the oblique side of the first and second touch electrodes 410 and 420. Accordingly, when deforming the touch sensor device 400, the possibility of separation of the first and second touch electrodes 410 and 420 from the first and second touch substrates 401 and 402 and generation of a fault such as a crack in the first and second touch electrodes 410 and 420 may be reduced.

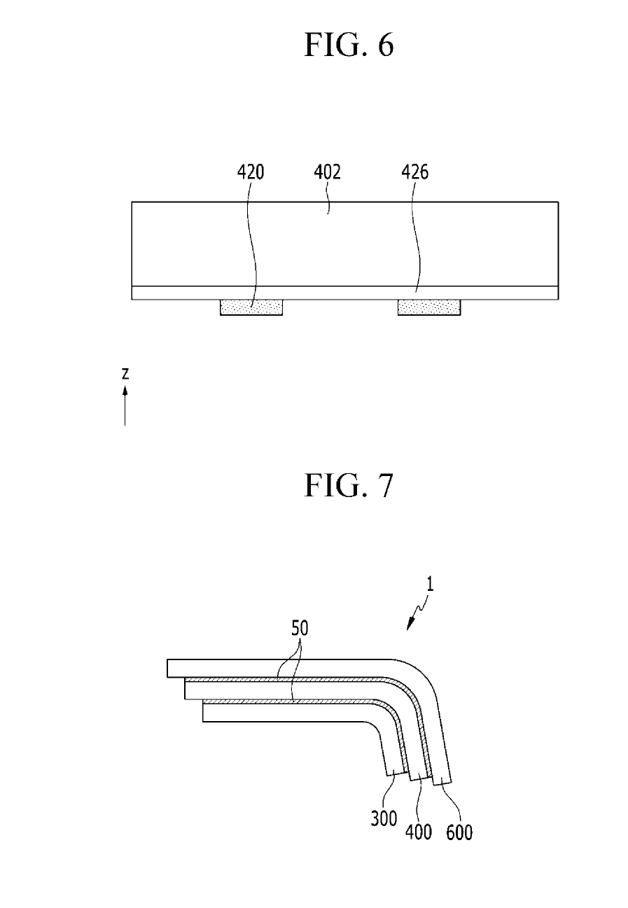

Next, a manufacturing method of the touch sensor device according to an exemplary embodiment will be described with reference to FIG. 5 and FIG. 6 along with the above-described drawings.

FIG. 5 is a cross-sectional view of a first touch substrate in a manufacturing process according to a manufacturing method of a touch sensor device according to an exemplary embodiment, and FIG. 6 is a cross-sectional view of a second touch substrate in a manufacturing process according to a manufacturing method of a touch sensor device according to an exemplary embodiment.

Referring to FIG. 5, a first touch substrate 401 made of a plastic, such as polyethylene terephthalate (PET), polyethylene naphthalate, polycarbonate, polyarylate, polyetherimide, polyether sulfone, polyimide, and the like, is formed. The insulating material, such as a silicon nitride (SiNx) and an aluminum oxide (AlOx), is coated thereon to form a protection layer 416. The protection layer 416 may be omitted without departing from the scope of the inventive concept.

The transparent conductive oxide, such as ITO (indium tin oxide) and IZO (indium zinc oxide), or the transparent conductive material, such as metal nanowire, conductive polymer such as PEDOT, metal mesh, and carbon nanotubes (CNT), is deposited and patterned on the protection layer 416 or is deposited with the patterned shape to form a plurality of first touch electrodes 410.

Referring to FIG. 6, a second touch substrate 402 made of the plastic, such as polyethylene terephthalate (PET), polyethylene naphthalate, polycarbonate, polyarylate, polyetherimide, polyether sulfone, polyimide, and the like, is formed. The insulating material, such as a silicon nitride (SiNx) and an aluminum oxide (AlOx), is coated thereon to form a protection layer 426. The protection layer 426 may be omitted without departing from the scope of the inventive concept.

The transparent conductive oxide, such as ITO (indium tin oxide) and IZO (indium zinc oxide), or the transparent conductive material, such as metal nanowire, conductive polymer such as PEDOT, metal mesh, and carbon nanotubes (CNT), is deposited and patterned on the protection layer 426 or is deposited with a patterned shape to form a plurality of second touch electrodes 420.

Referring to FIG. 2 or FIG. 4, at least one material selected from a ductile polymer, a liquid film, a resin, a photoresist, and a nonpolar solder resist is coated on the first touch substrate 401 formed with the first touch electrode 410 or on the second touch substrate 402 formed with the second touch electrode 420 to from the middle layer 430. Then the first and second touch substrates 401 and 402 are assembled. In this case, the first and second touch substrates 401 and 402 are assembled such that the first touch electrode 410 and the second touch electrode 420 face each other. The pressure when assembling the first and second touch substrates 401 and 402 may be controlled for the upper surface US of the first touch electrode 410 to be higher than the lower surface LS of the second touch electrode 420. After the assembling of the first and second touch substrates 401 and 402, the middle layer 430 may be hardened.

Next, the display device including the touch sensor device according to an exemplary embodiment of the present disclosure will be described with reference to FIG. 7 as well as the previously described drawings.

FIG. 7 is a cross-sectional view of a display device including a touch sensor device according to an exemplary embodiment.

Referring to FIG. 7, the display device 1 according to an exemplary embodiment may include a display panel 300, a touch sensor device 400, and a cover window 600.

The display panel 300 includes a display area as a region displaying an image, and a plurality of display signal lines connected to a plurality of pixels to transmit the driving signal may be positioned in the display area.

The touch sensor device 400 is the same as the touch sensor device 400 of the above several exemplary embodiments such that the detailed description thereof is omitted.

The touch sensor device 400 may be attached on the display panel 300 through an adhesive such as an OCA (optical clear adhesive), an OCR (optical clear resin), and a PSA (pressure sensitivity adhesive).

The touch sensing region TA of the touch sensor device 400 may correspond to the display area of the display panel 300, however it is not limited thereto.

The cover window 600 may be positioned on the touch sensor device 400. The cover window 600 may be made of the insulating material such as plastic or glass. The cover window 600 may be flexible or hard. The surface of the cover window 600 may include a touch surface that the external object may contact.

The cover window 600 may be adhered on the touch sensor device 400 through the adhesive such as the OCA, OCR, and PSA.

Referring to FIG. 7, the display device 1 including the touch sensor device 400 has flexibility such that the display device 1 may be deformed or bendable by the user, or may alternatively be fixed in the bent state. The display device 1 having the fixed state may be partially or entirely curved or bent. In this case, the neutral plane NP of the touch sensor device 400 of the portion that is bent or curved is positioned at the touch electrode layer 403 such that a failure, such as a crack of the touch electrodes 410 and 420, may be prevented.

In the present exemplary embodiment, to position the neutral plane NP at the touch electrode layer 403 of the touch sensor device 400 in the bent portion of the display device 1, material characteristics such as the thickness, the elasticity coefficient of the display panel 300, the cover window 600, the touch sensor device 400, and the adhesive 50 therebetween may be controlled.

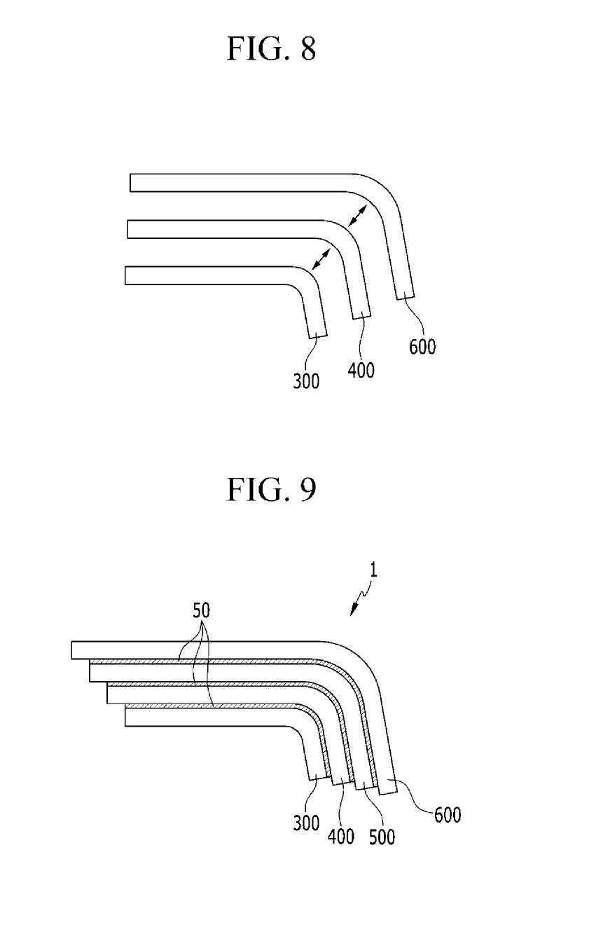

Now, a manufacturing method of the display device including the touch sensor device according to an exemplary embodiment will be described with reference to FIG. 8 along with FIG. 7.

FIG. 8 is a cross-sectional view showing an assembling method of a display panel, a touch sensor device, and a cover window in a manufacturing process of the display device shown in FIG. 7,

Referring to FIG. 8, after forming the display panel 300, the touch sensor device 400 is adhered to the upper surface thereof. Next, the cover window 600 may be adhered to the upper surface of the touch sensor device 400 by using an adhesive. The adhering order of the display panel 300, the touch sensor device 400, and the cover window 600 may be changed without departing from the scope of the inventive concept.

When the display device 1 has a fixed state that is curved and/or bent, the cover window 600 may be manufactured in the curved and/or bent state, and may be adhered as-is to the touch sensor device 400. Alternatively, a flexible cover window 600 may be adhered to the touch sensor device 400 in the bent state.

The flexible touch sensor device 400 is deformed depending on the shape of the display panel 300 or the cover window 600 to be adhered to the display panel 300 and the cover window 600. In this case, as described above, the neutral plane NP of the touch sensor device 400 is positioned at the touch electrode layer 403 such that damage to the touch electrode 410 and 420 may be prevented.

The display device including the touch sensor device according to an exemplary embodiment will now be described with reference to FIG. 9.

FIG. 9 is a cross-sectional view of a display device including a touch sensor device according to an exemplary embodiment.

Referring to FIG. 9, the display device 1 according to an exemplary embodiment is mostly the same as the display device according to the exemplary embodiment shown in FIG. 7 except for a polarizer 500.

The polarizer 500 may be positioned between the touch sensor device 400 and the cover window 600. The polarizer 500 may be adhered to the upper surface of the touch sensor device 400 through the adhesive 50 such as the OCA, OCR, and PSA.

The polarizer 500 may be formed of a flexible film. The polarizer 500 may include PVA (polyvinyl alcohol), and at least one supporting member may be adhered at both sides thereof. The supporting member may include TAC (triacetyl cellulose), CAP (cellulous acetate propionate), or WV-TAC (wide view-TAC). The adhesive may be formed at at least one surface of the polarizer 500.

The polarizer 500 may prevent external light reflected from the several electrodes and wires included in the display panel 300 and the touch sensor device 400 positioned thereunder from being recognized by an observer. That is, the light that is incident inside the display device 1 passes through the polarizer 500, is reflected from the electrodes or the wires thereunder, and is again incident to the polarizer 500 to generate destructive interference for the light that is just incident to the polarizer 500 such that the light may not be recognized outside.

The polarizer 500 may be a circular polarizer, and in this case, the polarizer 500 may include a linear polarizer and a quarter-wave plate.

If the polarizer 500 is positioned at the side of the external observer and the touch sensor device 400 is positioned between the display panel 300 and the polarizer 500, the light reflected by the pattern of the touch electrodes 410 and 420 and the touch wires 411 and 421 of the touch sensor device 400 may not be recognized by the external observer.

In the present exemplary embodiment, in the bent portion of the display device 1, the material characteristics such as the thickness, the elasticity coefficient, and the like of the display panel 300, the polarizer 500, the cover window 600, the touch sensor device 400, and the adhesive 50 therebetween may be controlled so as to position the neutral plane NP at the touch electrode layer 403 of the touch sensor device 400.

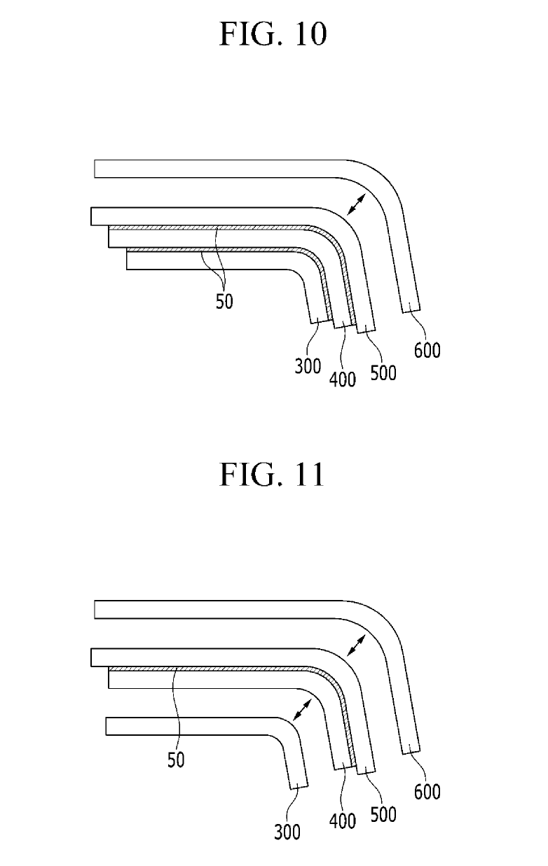

Next, the manufacturing method of the display device including the touch sensor device according to an exemplary embodiment will be described with reference to FIG. 10 and FIG. 11 as well as FIG. 9.

FIG. 10 is a cross-sectional view showing an assembling method of a display panel, a touch sensor device, a polarizer, and a cover window in a manufacturing process of the display device shown in FIG. 9. FIG. 11 is a cross-sectional view showing another exemplary assembling method of a display panel, a touch sensor device, a polarizer, and a cover window in a manufacturing process of the display device shown in FIG. 9.

Referring to FIG. 10, after forming the display panel 300, the touch sensor device 400 is adhered to the upper surface thereof. Next, the polarizer 500 may be adhered to the upper surface of the touch sensor device 400 by using the adhesive. The adhering order of the display panel 300, the touch sensor device 400, and the polarizer 500 may be changed without departing from the scope of the inventive concept.

Next, the cover window 600 may be adhered to the display panel 300, the touch sensor device 400, and the polarizer 500 that are adhered to each other by using the adhesive. The cover window 600 may be adhered to the upper surface of the polarizer 500.

When the display device 1 has the fixed state, the cover window 600 may be manufactured in the curved and/or bent state and may be adhered as-is to the polarizer 500. Alternatively, a flexible cover window 600 may be adhered to the touch sensor device 400 in the bent state.

The flexible touch sensor device 400 is deformed depending on the shape of the display panel 300 when being assembled to the display panel 300 to be adhered to the display panel 300. In this case, as described above, the neutral plane NP of the touch sensor device 400 is positioned at the touch electrode layer 403 such that damage to the touch electrode 410 and 420 may be prevented.

Referring to FIG. 11, after firstly manufacturing the touch sensor device 400, the polarizer 500 is adhered to the upper surface thereof by using the adhesive 50.

Next, the touch sensor device 400 assembled to the polarizer 500 is adhered to the upper surface of the manufactured display panel 300 by using the adhesive. The cover window 600 may then be adhered to the upper surface of the polarizer 500. The cover window 600 may be adhered to the upper surface of the polarizer 500. The adherence order of the display panel 300, the assembled touch sensor device 400 and polarizer 500, and the cover window 600 may be changed without departing from the scope of the inventive concept.

When the display device 1 has the fixed state, the cover window 600 may be manufactured in the curved and bent state and may be adhered as it is to the assembled polarizer 500 and the touch sensor device 400. Alternatively, a flexible cover window 600 may be adhered to the touch sensor device 400 and the polarizer 500.

When the assembled touch sensor device 400 and polarizer 500 are assembled to the display panel 300, they are deformed depending on the shape of the display panel 300 to be adhered to the display panel 300. As described above, the neutral plane NP of the touch sensor device 400 is positioned at the touch electrode layer 403 such that the damage to the touch electrodes 410 and 420 may be prevented.

According to an exemplary embodiment of the present disclosure, stress applied to the touch electrode when the flexible touch sensor device is deformed may be minimized such that the failure of the touch sensor due to the deformation may be prevented.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A touch sensor device comprising:
a first touch substrate and a second touch substrate disposed facing each other; and
a touch electrode layer disposed between the first touch substrate and the second touch substrate,
wherein the touch electrode layer comprises:
first touch electrodes positioned on the first touch substrate,
second touch electrodes positioned on the second touch substrate, and
a middle layer disposed between the first touch electrode and the second touch electrode, and
wherein the middle layer comprises at least one material selected from the group consisting of a ductile polymer, a liquid film, a resin, a photoresist, and a nonpolar solder resist.

2. The touch sensor device of claim 1, wherein an upper surface of the first touch electrode is positioned higher than a lower surface of the second touch electrode.

3. The touch sensor device of claim 2, wherein:
the touch sensor device comprises a bent portion, and
a neutral plane of the bent portion is positioned at the touch electrode layer.

4. The touch sensor device of claim 3, wherein a thickness of the first touch substrate is substantially identical to a thickness of the second touch substrate.

5. The touch sensor device of claim 4, wherein a thickness of the first touch electrode is substantially identical to a thickness of the second touch electrode.

6. The touch sensor device of claim 3, wherein the first and second touch substrates comprise a plastic selected from the group consisting of polyethylene terephthalate (PET), polyethylene naphthalate, polycarbonate, polyarylate, polyetherimide, polyether sulfone, and polyimide.

7. The touch sensor device of claim 1, wherein:
the touch sensor device comprises a bent portion, and
a neutral plane of the bent portion is positioned at the touch electrode layer.

8. The touch sensor device of claim 1, wherein a thickness of the first touch substrate is substantially identical to a thickness of the second touch substrate.

9. The touch sensor device of claim 8, wherein a thickness of the first touch electrode is substantially identical to as a thickness of the second touch electrode.

10. The touch sensor device of claim 1, wherein the first and second touch substrates comprise a plastic selected from the group consisting of polyethylene terephthalate (PET), polyethylene naphthalate, polycarbonate, polyarylate, polyetherimide, polyether sulfone, and polyimide.

11. A display device comprising:
a display panel configured to display an image; and
a touch sensor device disposed on the display panel,
wherein the touch sensor device comprises a first touch substrate and a second touch substrate facing each other, and a touch electrode layer disposed between the first touch substrate and the second touch substrate, and
the touch electrode layer comprises a plurality of first touch electrodes disposed on the first touch substrate, a plurality of second touch electrodes disposed on the second touch substrate, and a middle layer disposed between the first touch electrode and the second touch electrode, and
the middle layer comprises at least one material selected from the group consisting of a ductile polymer, a liquid film, a resin, a photoresist, and a nonpolar solder resist.

12. The display device of claim 11, wherein an upper surface of the first touch electrode is positioned higher than a lower surface of the second touch electrode.

13. The display device of claim 11, wherein:
the touch sensor device comprises a bent portion, and
a neutral plane of the bent portion is positioned at the touch electrode layer.

14. The display device of claim 13, wherein a thickness of the first touch substrate is substantially identical to a thickness of the second touch substrate.

15. The display device of claim 14, wherein a thickness of the first touch electrode is substantially identical to a thickness of the second touch electrode.

16. The display device of claim 13, wherein the first and second touch substrates comprise a plastic selected from the group consisting of polyethylene terephthalate (PET), polyethylene naphthalate, polycarbonate, polyarylate, polyetherimide, polyether sulfone, and polyimide.

17. The display device of claim 11, further comprising a cover window disposed on the touch sensor device.

18. The display device of claim 17, further comprising a polarizer disposed between the cover window and the touch sensor device.

19. The display device of claim 18, wherein:
the display device comprises a bent portion, and
a neutral plane of the bent portion is positioned at the touch electrode layer.

20. The display device of claim 17, wherein:
the display device comprises a bent portion, and
a neutral plane of the bent portion is positioned at the touch electrode layer.
